(19) United States
(12) Patent Application Publication
(10) Pub. No.: US 2004/0121839 A1
(43) Pub. Date: Jun. 24, 2004

(54) Gaming apparatus

(75) Inventor: Derek John Webb, Derby (GB)

Correspondence Address: NIXON & VANDERHYE, PC, 1100 N GLEBE ROAD, 8TH FLOOR, ARLINGTON, VA, 22201-4714, US

(73) Assignee: Prime Table Games LLC, Las Vegas, NV (US)

(21) Appl. No.: 10/712,297

(22) Filed: Nov. 14, 2003

(30) Foreign Application Priority Data
Nov. 16, 2002 (GB) 0226827.4

(51) Int. Cl. G06F 17/00; A63F 13/00

(52) U.S. Cl. 463/29; 463/11

(57) ABSTRACT

Gaming apparatus relating to a card game provides a screen image showing dealer cards 42 and players' cards 40. Player cards may be dealt face down, according to the game being played. Player controls 56 allow the player to control how the cards are revealed at the appropriate stage of the game. Thus, they may be revealed individually, allowing the player to adopt a strategy in which bets are placed as soon as a hand is found to meet a minimum strength, but without knowing the full strength of the hand. This adds to the excitement of play. The controls 56 also allow a player to instruct wagers to be made automatically when a hand meets a minimum requirement, thus speeding up game play.

The present invention relates to gaming apparatus.

Gaming apparatus has previously been proposed for simulating the playing of a card game. In some proposals, a player is presented with a screen image which shows cards being played in the game. Controls are provided to allow the player to interact with the game, for instance to make wagers. Previously, players who have experience of live card games have found that the quality of simulation is inadequate to provide the same enjoyment and excitement as is provided from a live game and thus may prefer to play a live game. However, gaming apparatus rather than live games may be more attractive to the casino operator or other games provider, because gaming apparatus does not require croupiers or other personnel, and allows faster play.

The present inventor has realised that by means of the present invention, the quality of simulation provided by gaming apparatus can be improved.

The present invention provides gaming apparatus operable by a player to simulate a card game in which a hand of cards is dealt to the player, the apparatus comprising:

input means operable to receive instructions initiated by a player and relating to the playing of the game;

output means operable to provide data for creating a display image representing the current state of the game being played, and

control means operable to maintain a record of the current state of the game being played, to modify the record in accordance with the rules of the game, and to cause the display image data to be updated as the game progresses,

and wherein the apparatus is operable to cause the display image data to create an image of a player hand including at least one obscured card when first dealt, and is further operable to modify the display image data in accordance with player instructions received by the input means, to cause the created image to reveal the or each obscured card in a manner determined by the player.

Preferably, the control means is operable in response to received instructions to control the speed and/or order and/or timing of obscured cards being revealed. The apparatus may be operable to provide an image of a partially revealed card.

Preferably the whole of the player hand is initially obscured. Preferably the apparatus is operable to provide display image data which creates an image in which an obscured card is represented by an image of a face down card.

The input means may include player control means by which instructions may be initiated. The player control means may include a touch screen means and/or mechanical or electro-mechanical actuators and/or image locations selectable by a player control to indicate a corresponding instruction.

The output means may include a display means operable in response to display image data to create a display image.

Alternatively, the input means and output means may communicate over a network to receive instructions and provide display image data.

The invention also provides computer software which, when installed on a computer system, is operable to provide gaming apparatus as defined above.

The invention also provides a carrier medium carrying computer software as defined in the previous paragraph. The carrier medium may be a memory device.

In a second aspect, the invention provides gaming apparatus operable by a player for the simulation of a card game in which a hand of cards is dealt to the player, the apparatus comprising:

player control means operable by a player to initiate instructions relating to the playing of the game; and

display means operable to receive display image data representing the current state of a game being played and to create a display image corresponding thereto;

the player instructions being sent to, and the display image data being received from control means operable to maintain a record of the current state of the game being played, to modify the record in accordance with the rules of the game, and to cause the display image data to be updated as the game progresses, and wherein the control means is further operable to cause the display image data to create an image of a player hand including at least one obscured card when first dealt, and to modify the display image data in accordance with the player instructions initiated by the player control means to cause the created image to reveal the or each obscured card in a manner determined by the player.

Preferably the player control means are operable by a player to create player instructions which control the speed and/or order and/or time at which an obscured card is revealed. The control means may be operable to cause the display image data to create an image of a partially revealed card. Preferably an image of an obscured card is presented as an image of a face down card.

The player control means may include a touch screen and/or mechanical or electro-mechanical controls and/or an image region selectable by a player to initiate a corresponding instruction.

Preferably the apparatus communicates with the control means over a network.

The invention also provides computer software which, when installed on a computer system, is operable to provide gaming apparatus as defined in the previous four paragraphs.

The invention also provides a carrier medium carrying computer software as defined in the previous paragraph. The carrier medium may be a memory device. Alternatively, the medium may be a transmission medium, the software being carried by a signal propagating on the transmission medium.

The invention also provides a signal propagating on a transmission medium, the signal representing software which, when installed on a computer system, is operable to provide gaming apparatus as defined above.

In a further aspect, the invention provides a method of simulating a card game for playing by a player, the game being in the form in which a hand of cards is dealt to the player, the method including:

receiving instructions initiated by a player and relating to the playing of the game;

providing data for creating a display image representing the current state of the game being played; and

maintaining a record of the current state of the game being played, modifying the record in accordance with the rules of the game, and causing the display image data to be updated as the game progresses;

and wherein the display image data is caused to create an image of a player hand which includes at least one obscured card when first dealt, and is modified in accordance with player instructions received, to cause the created image to reveal the or each obscured card in a manner determined by the player.

Preferably the obscured card or cards are revealed at a speed and/or order and/or time set by the player. The method may cause an image of a partially revealed card to be provided to a player.

Initially, all cards of the player hand are preferably obscured. The display image data preferably causes an obscured card to be represented by an image of a face down card.

The instructions and/or display image data may be transmitted over a network.

In a further aspect, the invention provides gaming apparatus operable by a player to simulate a card game in which a hand of cards is dealt to the player, the apparatus comprising:

input means operable to receive instructions initiated by a player and relating to the playing of the game;

output means operable to provide data for creating a display image representing the current state of the game being played, and

control means operable to maintain a record of the current state of the game being played, to modify the record in accordance with the rules of the game, and to cause the display image data to be updated as the game progresses;

and wherein the apparatus is operable to receive a player instruction representing at least one wager criterion, and to assess the player hand in accordance with the wager criterion or criteria, and to effect the placing of a wager, without player intervention, in the event that the wager criterion or criteria are met.

Preferably a wager criterion is interpreted as a minimum hand strength required for a wager to be placed. Preferably, the cards of a player hand are sequentially assessed by the control means and a wager is placed if the hand meets the or a wager criterion, without further assessment being made. The apparatus may be operable to cause the display image data to create an image of a player hand which includes at least one obscured card when first dealt. Cards may remain obscured if they have not been incorporated in an assessment of the strength of the hand against the wager criterion or criteria.

The apparatus may be further operable to modify the display image data in accordance with player instructions received by the input means, to cause the created image to reveal the or each obscured card in a manner determined by the player.

In another aspect, the invention provides computer software which, when installed on a computer system, is operable to provide gaming apparatus as defined in any of the previous three paragraphs.

The invention also provides a carrier medium carrying computer software according to the previous paragraph. The carrier medium may be a memory device.

In a further aspect, the invention provides gaming apparatus operable by a player for the simulation of a card game in which a hand of cards is dealt to the player; the apparatus comprising:

player control means operable by a player to initiate instructions relating to the playing of the game; and

display means operable to receive image data representing the current state of a game being played and to create a display image corresponding thereto;

the player instructions being sent to, and the display image data being received from control means operable to maintain a record of the current state of the game being played, to modify the record in accordance with the rules of the game, and to cause the display image data to be updated as the game progresses, and wherein the control means is further operable to receive a player instructions representing at least one wager criterion, and to assess the player hand in accordance with the criterion or criteria, and to effect the placing of a wager, without player intervention, in the event that the wager criterion or criteria are met.

Preferably a wager criterion is interpreted as a minimum hand strength required for a wager to be placed. Preferably, the cards of a player hand are sequentially assessed by the control means and a wager is placed if the hand meets the or a wager criterion, without further assessment being made. The apparatus may be operable to cause the display image data to create an image of a player hand which includes at least one obscured card when first dealt. Cards may remain obscured if they have not been incorporated in an assessment of the strength of the hand against the wager criterion or criteria.

The apparatus may be further operable to modify the display image data in accordance with player instructions received by the input means, to cause the created image to reveal the or each obscured card in a manner determined by the player.

In another aspect, the invention provides computer software which, when installed on a computer system, is operable to provide gaming apparatus as defined in any of the previous three paragraphs.

The invention also provides a carrier medium carrying computer software according to the previous paragraph. The carrier medium may be a memory device.

The invention also provides a signal propagating on a transmission medium, the signal representing software which, when installed on a computer system, is operable to provide gaming apparatus as defined above.

In a further aspect, the invention provides a method of simulating a card game for playing by a player, the game being in the form in which a hand of cards is dealt to the player, the method including:

receiving instructions initiated by a player and relating to the playing of the game;

providing data for creating a display image representing the current state of the game being played; and

maintaining a record of the current state of the game being played, modifying the record in accordance with the rules of the game, and causing the display image data to be updated as the game progresses;

and wherein a player instruction representing at least one wager criterion is received, and the player hand is assessed in accordance with the criterion or criteria, and a wager is placed, without player intervention, in the event that the wager criterion or criteria are met.

Preferably a wager criterion is interpreted as a minimum hand strength required for a wager to be placed. Preferably, the cards of a player hand are sequentially assessed and a wager is placed if the hand meets the or a wager criterion, without further assessment being made. An image of a player hand may be created which includes at least one obscured card when first dealt. Cards may remain obscured if they have not been incorporated in an assessment of the strength of the hand against the wager criterion or criteria.

The display image data may be modified in accordance with player instructions received by the input means, to cause the created image to reveal the or each obscured card in a manner determined by the player.

Embodiments of the present invention will now be described in more detail, by way of example only, and with reference to the accompanying drawings, in which:

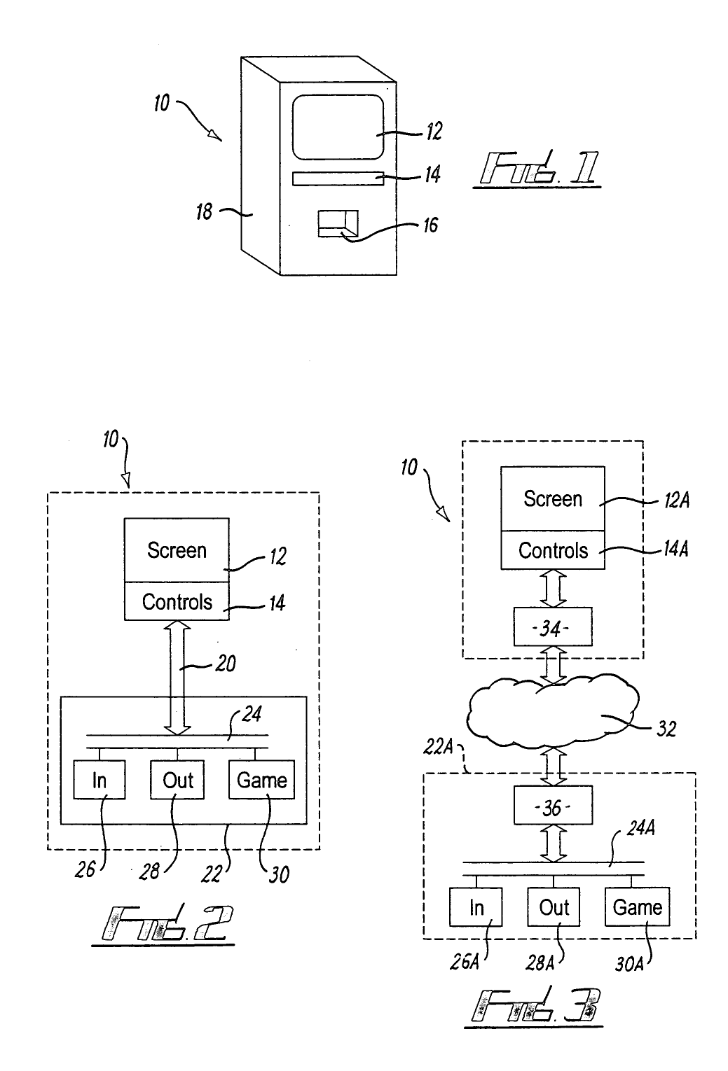

FIG. 1 is a highly schematic perspective view of a first embodiment of gaming apparatus in accordance with the present invention;

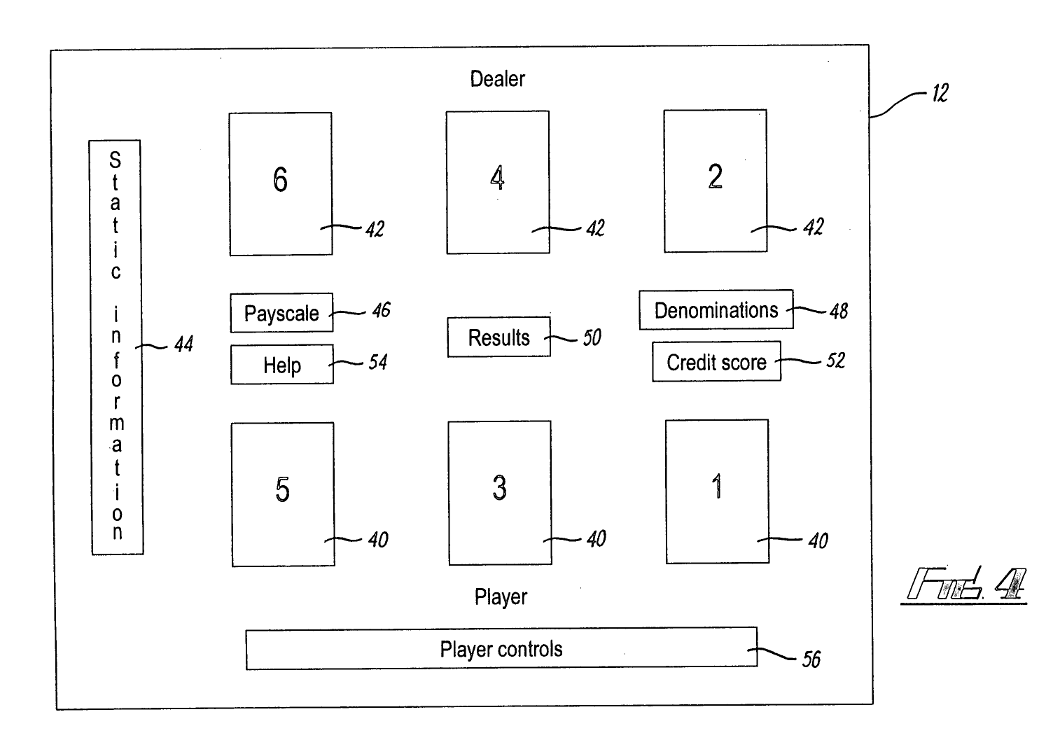

FIG. 2 is a simplified and schematic diagram of operative components of the apparatus of FIG. 1;

FIG. 3 corresponds with FIG. 2, representing an alternative embodiment;

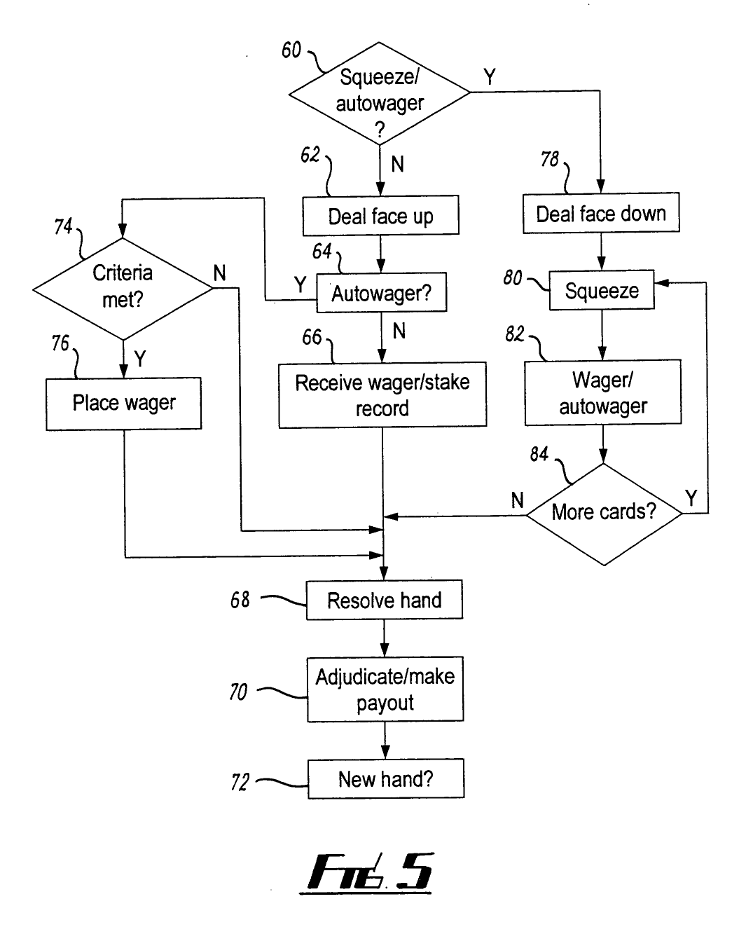

FIG. 4 illustrates a simplified and schematic screen image provided on the screen of either embodiment; and

FIG. 5 is a flow chart illustrating the manner in which the invention may be performed.

### CARD GAME CHARACTERISTICS

The embodiments which will be described are for simulating card games, particularly house banked card games, in which a player is dealt a hand which is initially face down. For example, in table games of poker or brag, cards are dealt face down to a player. Other hands, particularly a dealer hand, may also be dealt. The player has control over how and when they look at the player hand. This is in contrast with other types of game, such as blackjack, in which the player hand is conventionally dealt face up and is therefore immediately visible to all players.

### First Embodiment

FIG. 1 schematically illustrates gaming apparatus 10 which is operable by a player to simulate a card game in which a hand of cards is dealt to the player. FIG. 1 illustrates the external appearance of the apparatus 10. The card game is simulated on a screen 12 viewed by the player. Various user controls 14 are provided, by means of which the player may initiate instructions relating to the playing of the game. In this example, the controls 14 are shown separate for the screen 12. Other possibilities will be described below. Other facilities may be provided, indicated generally at 16, such as to allow payments to be taken or payouts made. The apparatus is contained within a housing 18.

FIG. 2 illustrates the arrangements internally of the housing 18. The screen 12 and controls 14 are shown as a unitary block in FIG. 2, for reasons which will become apparent. This block communicates by means of a bus 20 with a control arrangement 22, preferably in the form of a programmable computer. Within the computer 24, data from the external bus 22 passes to an internal bus 24 to which three modules 26, 28, 30 are connected. Module 26 is an input module. Module 28 is an output module. Module 30 is a control module.

The input module 26 is operable to receive instructions initiated by a player and relating to the playing of the game. These instructions may be initiated by operation of the player controls 14.

The output module 28 is operable to provide data, on the bus 20, for creating a display image, on the screen 12, representing the current state of the game being played.

The control module 30 maintains a record of the current state of the game being played and modifies the record in accordance with the rules of the game. Communication between the control module 30 and the output module 28, on the bus 24, allows the display image data to be updated as the game progresses.

The control module 30 also causes the display image data to create an image of a player hand which includes at least one obscured card when first dealt, and to reveal the or each obscured card in a manner determined by the player, as the game progresses. This will be explained in more detail below.

Communication between the various modules 26, 28, 30 is provided by the internal bus 24. The modules 26, 28, 30 may be software modules executed on an appropriate processor device, or hardware modules performing corresponding functions, or may be implemented as a combination of hardware and software.

### Second Embodiment

FIG. 3 illustrates an alternative embodiment, in which many components correspond with those of FIG. 2 and are thus given like references, with the suffix A. In the arrangement of FIG. 3, communication over the bus 20 is replaced by communication by means of a network 32. The screen 12 and player controls 14 are connected at 34 to the network 32. The internal bus 24A is also connected to the network, at 36. This may require the use of one or more modem devices, or other communication equipment. The function of the connections 34, 36 and the network 32 is to provide a link between the screen 12A and player controls 14A on the one hand, and the control arrangement 22A on the other hand. Thus, the arrangement is equivalent to the embodiment of FIG. 2, but the control arrangement 22 may be located at a remote location from that of the screen 12A and player controls 14A. This allows remote playing of a game simulated by the control arrangement 22A.

For example, the network 32 may be a communication network such as the internet or an intranet. The control arrangement 22A may be created by appropriately programming a personal computer owned by the player, such as a home computer, allowing communication with the control arrangement 22A in order to play the game. Alternatively, the arrangements may be implemented as a range of terminals, for example at one or more casinos, interconnected by an intranet to a control arrangement 22 operated by the casino operator.

Screen Image

In either embodiment, the screen image viewed by a player may be as shown in FIG. 4.

The description of the screen image of FIG. 4 will be made with reference to the numeral 12 to refer to the screen, but it is to be understood that the same image can be created by the embodiment of FIG. 3, on the screen 12A.

The image on the screen 12 has six positions 40, 42 at which images of cards may be created. Player cards are displayed at positions 40. Dealer cards are displayed at positions 42. The positions 40, 42 represent the most significant images on the screen. A region 44 at the border of the screen 12 displays static information, such as the rules of the game, or other information to attract a player. Other static information may be provided, such as a pay scale 46, indicating the manner in which payouts are calculated when a hand is resolved. Other regions, such as the region 48, may display dynamic or static information, such as the denominations in which wagers are accepted. This may be static or may change at different stages of a game. Dynamic information may be displayed, such as results at 50, or credit remaining to a player, at 52. An interactive region may be provided at 54. This may be selected, for example by operation of a cursor control device, to call an alternative image, such as help information or additional assistance for playing the game. A further region 56 may be interactive by cursor control, to provide the player controls 14, 14A. For example, the player controls 14, 14A may be represented as buttons or other controls in the region 56, which controls can be operated by cursor control in a manner conventional in itself. Alternatively, the player controls 14, 14A may be embodied as a touch sensitive region of the screen. In a further alternative, the player controls 14, 14A may be mechanical or electro-mechanical devices operated by hand by the player. These are provided at a convenient location in the vicinity of the screen 12.

When using the screen image of FIG. 4, a game can be played such as the Three Card Poker game invented by the present inventor and described in detail in U.K. Patent No. 2291360. Three Card Poker is a live table game in which a player hand and a dealer hand are both dealt face down. Consequently, this is replicated by the screen image initially showing three face down cards at 40, and another three face down dealer cards at 42. Cards to be obscured are preferably shown as an image of a face down card, to better simulate a live table game, but could alternatively be obscured in other ways, such as by corruption or distortion of the screen image of a face-up card.

Squeeze Option

In the game being played, a hand is resolved by comparison of the cards in the dealer hand with those in the player hand, in accordance with the rules of the game being played. In accordance with the invention, the player is able to control the manner in which player cards 40, initially obscured, are revealed to the player.

For example, a suitable user control 56 may be used to reveal a first one of the player cards 40. This is achieved by the player operating the appropriate player control 14, 14A to initiate an instruction which is sent to the input module 26, 26A, where the received signal is interpreted as the corresponding instruction and passed to the control module 30, 30A. The control module 30, 30A consults the record of the current state of the game being played, decides on the card to be displayed in accordance with that record, and communicates that information to the output module 28, 28A. The output module 28, 28A interprets that instruction by modifying the display image data being output to the screen 12, 12A, so that the image on the screen 12 is changed to reveal the card in accordance with the instruction from the player.

In this way, a player may instruct an obscured card to be revealed, equivalent to turning over a face down card to be face up. In order to enhance player enjoyment, it is preferable to allow the player to control the speed, order and timing of cards being revealed. Some players may also require a card to be only partially revealed, in which case, an appropriate instruction can be initiated from the controls 56, with a consequent modification of the display image.

In a preferred example, the controls 56 may allow a user to select and turn over the cards individually, and to leave one or more cards obscured. While manipulating the player hand in this way, the player may, at any time, place a wager in accordance with the wager rules (for example restrictions on denominations of wagers) and the credit remaining to the player. For example, some players may wish to reveal cards sequentially, assessing the hand after each card has been revealed. Strategies known to the player may define a minimum hand strength required for a wager to be placed. A player may choose to wager as soon as it is apparent that the hand meets or exceeds the minimum criterion for placing a wager, but without going on to reveal any remaining obscured cards. Consequently, the player does not know the full strength of the hand at the time the wager is placed. This provides a degree of additional tension and excitement to the player, while the player waits for the hand to be resolved in accordance with the rules of the game.

Each stage of play is initiated by the player using the controls 56 to initiate an instruction which is processed at 22, 22A, as has been described, in order to modify the screen image. At the appropriate point in the game, the hand is resolved by the control module 30, 30A by revealing the dealer hand to the player, and any player cards not yet revealed. The control module 30, 30A then determines the outcome and then determines the pay out, if any, due to the player. The pay out may be credited (with appropriate updating of the credit score 52), or coins or tokens may be paid out by the mechanism 16 (FIG. 1). Credit may be financial or credits for further game play, or for use elsewhere in the establishment, such as for playing other games.

Player enjoyment can be enhanced, as has been said, by controlling the sequential revealing of the player cards 40. At each occasion a player card 40 is revealed, player enjoyment may be still further enhanced by allowing the player to control the speed at which the card is revealed. For example, a pressure sensitive control may be provided at 56, allowing a player to use variable pressure to instruct a corresponding reveal speed.

Automatic Wager

In some card games, as has been indicated, a player may wish to use a wager strategy in which a wager will be placed only if a hand meets or exceeds a minimum criterion, but not otherwise. Generally, a minimum criterion of this nature will be selected in accordance with the underlying statistical probabilities of the game being played. For example, in the game of Three Card Poker, a reasonable wager strategy is to place a wager on any hand with Queen high or better, although the precise strategy which is statistically best is to place a wager with Queen, six, four or better. However, the difference between these two strategies is minimal. The simpler strategy is to wager on Queen high or better. For example, this would allow a player to place a wager in the event that the first revealed card is a Queen (so that the hand is necessarily Queen high or better) but without revealing the other two cards. The player is then kept in suspense as to the precise outcome of the hand until the remaining two cards are made known to the player, prior to the hand being resolved.

The invention envisages that a player is provided with a facility to record the minimum criterion by which that player wishes to place wagers, so that wagers can automatically be played, without further user intervention, in the event that the minimum criterion is met or exceeded.

Thus, to make use of this facility, a user operates the controls 56 to initiate an instruction that automatic wager is to be used. The player may be allowed to define the minimum criterion required for a wager to be placed. This information is dispatched from the player controls 14, 14A to the input module 26, 26A which interprets this information for use by the control module 30, 30A. As play proceeds, the control module 30, 30A is therefore able to determine, at each stage, whether or not the criterion has been met. If so, the control module 30, 30A effects the placing of a wager, without player intervention, by modifying the record of the current state of the game being played. Corresponding information is provided to the output module 28, 28A, so that the display image data can be updated to cause the screen image to indicate to the player that a wager has been made.

It is envisaged that this automated procedure will allow game play to be faster, which is attractive to the owner of the machine in increasing revenue, and to the player, in simplifying game play without departing from the chosen wager strategy.

The apparatus may incorporate controls by which a player may place additional wagers, even if the automatic wager facility is in use. Naturally, any wagers placed, including automatic wagers, must comply with the rules of the game, such as rules relating to the denominations of wagers, and the credit available to the player.

Flow Chart

FIG. 5 is a flow chart indicating the sequence of operations for playing a hand when the squeeze option and automatic wager facility are both available to the player.

At the beginning of the game, step 60, the player indicates whether or not the squeeze option or the automatic wager facility are to be used. In the event that the squeeze option is not being used, a player hand is dealt face up at 62. Step 64 checks if the automatic wager facility is being used. If not, a wager may be received at 66 by manual intervention. The nature of the wager and the associated stake are recorded for use by the control module. The hand is then resolved at 68, any payout is adjudicated and made at 70, and the hand closes, preferably with the player being offered the opportunity of playing a further hand, at 72.

In an alternative branch, if the squeeze option is not in use, but the automatic wager facility is being used, step 64 is followed by an assessment at 74. This step assesses the player hand against the minimum wager criterion which applies. If the hand does not meet the minimum criterion, the hand is resolved at 68 without a wager being placed. Consequently, no payout will be appropriate at 70. The hand concludes again at 72.

However, if step 74 finds that the minimum criterion is met or exceeded, a wager is placed automatically at 76, without player intervention. The hand is then resolved at 68 and an appropriate payout adjudicated and made at 70, before the hand finishes at 72.

The alternatives described above have all assumed that the squeeze option is not being used. In the following alternatives, the squeeze option has been selected by the player. Consequently, instead of a face-up deal at 62, cards are dealt at 78 with the player hand face down. Squeeze instructions are received at 80 from the player. As each card is revealed, step 82 allows a wager to be placed either by manual intervention or automatically, if the minimum criterion has been met. Step 84 decides if further cards remain to be squeezed and if so, returns to step 80. If a wager or automatic wager has been placed at 82, the decision at 84 may automatically be to keep the remaining cards obscured or the player may be provided the option of continuing to reveal the remaining cards. When no further cards are to be revealed, the hand is resolved at 68, as described above, any payout is adjudicated and made at 70 and the hand concludes at 72.

Combinations of Features

It is envisaged that the squeeze option and automatic wager facility could be made available to players individually or in combination. Thus, the apparatus could operate to provide the squeeze option while requiring all wagers to be placed by player intervention. Alternatively, the automatic wager option may be available to a player without the squeeze option. However, it is particularly preferred to provide both options, so that a user has a choice of setting up an automatic wager or not, and can then control how the cards are revealed, by means of the squeeze option. This is expected to maximise player enjoyment and excitement.

Alternative Arrangements

It is envisaged that apparatus in accordance with the present invention can be embodied as self-contained apparatus, such as that illustrated in FIGS. 1 and 2. Alternatively, player consoles or terminals may be in communication with control arrangements at remote locations, such as servers on an intranet or the internet.

It is within the scope of the invention to envisage the apparatus being implemented by means of appropriately programmed general purpose computers and accordingly, it is within the scope of the invention to provide software to allow a general purpose computer to be programmed to implement the invention. This software may be carried by a carrier medium such as a memory device, or may be propagated as a signal, such as by downloading software onto a machine, over a communication network. For example, an operator may set up an internet or intranet server programmed to perform as a control arrangement and to provide software for downloading to a terminal or other general purpose machine, over the internet or intranet, allowing that machine to be programmed to provide the remaining components of the apparatus, at the user end of the apparatus.

Many variations and modifications can be made to the apparatus described above.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Gaming apparatus operable by a player to simulate a card game in which a hand of cards is dealt to the player, the apparatus comprising:
input means operable to receive instructions initiated by a player and relating to the playing of the game;
output means operable to provide data for creating a display image representing the current state of the game being played, and
control means operable to maintain a record of the current state of the game being played, to modify the record in accordance with the rules of the game, and to cause the display image data to be updated as the game progresses,
and wherein the apparatus is operable to cause the display image data to create an image of a player hand including at least one obscured card when first dealt, and is further operable to modify the display image data in accordance with player instructions received by the input means, to cause the created image to reveal the or each obscured card in a manner determined by the player.

2. Apparatus according to claim 1, in which the control means is operable in response to received instructions to control the speed and/or order and/or timing of obscured cards being revealed.

3. Apparatus according to claims 1 or 2, in which the apparatus is operable to provide an image of a partially revealed card.

4. Apparatus according to any of the preceding claims, in which the whole of the player hand is initially obscured.

5. Apparatus according to any of the preceding claims, in which the apparatus is operable to provide display image data which creates an image in which an obscured card is represented by an image of a face down card.

6. Apparatus according to any of the preceding claims, in which the input means includes player control means by which instructions are initiated.

7. Apparatus according to claim 6, in which the player control means includes a touch screen means and/or mechanical or electro-mechanical actuators and/or image locations selectable by a player control to indicate a corresponding instruction.

8. Apparatus according to any of the preceding claims, in which the output means includes a display means operable in response to display image data to create a display image.

9. Apparatus according to any of the preceding claims, in which the input means and output means communicate over a network to receive instructions and provide display image data.

10. Computer software which, when installed on a computer system, is operable to provide gaming apparatus according to any of the preceding claims.

11. A carrier medium carrying computer software according to claim 10.

12. A carrier medium according to claim 11, in which the carrier medium is a memory device.

13. Gaming apparatus operable by a player for the simulation of a card game in which a hand of cards is dealt to the player, the apparatus comprising:
player control means operable by a player to initiate instructions relating to the playing of the game; and
display means operable to receive display image data representing the current state of a game being played and to create a display image corresponding thereto;
the player instructions being sent to, and the display image data being received from control means operable to maintain a record of the current state of the game being played, to modify the record in accordance with the rules of the game, and to cause the display image data to be updated as the game progresses, and wherein the control means is further operable to cause the display image data to create an image of a player hand including at least one obscured card when first dealt, and to modify the display image data in accordance with the player instructions initiated by the player control means to cause the created image to reveal the or each obscured card in a manner determined by the player.

14. Apparatus according to claim 13, in which the player control means are operable by a player to create player instructions which control the speed and/or order and/or time at which an obscured card is revealed.

15. Apparatus according to claims 13 or 14, in which the control means are operable to cause the display image data to create an image of a partially revealed card.

16. Apparatus according to any of claims 13 to 15, in which an image of an obscured card is presented as an image of a face down card.

17. Apparatus according to any of claims 13 to 16, in which the player control means include a touch screen and/or mechanical or electro-mechanical controls and/or an image region selectable by a player to initiate a corresponding instruction.

18. Apparatus according to any of claims 13 to 17, in which the apparatus communicates with the control means over a network.

19. Computer software which, when installed on a computer system, is operable to provide gaming apparatus according to any of claims 13 to 18.

20. A carrier medium carrying computer software according to claim 19.

21. A carrier medium according to claim 20, in which the carrier medium is a memory device.

22. A carrier medium according to claim 20, in which the medium is a transmission medium, the software being carried by a signal propagating on the transmission medium.

23. A signal propagating on a transmission medium, the signal representing software which, when installed on a computer system, is operable to provide gaming apparatus according to any of claims 13 to 18.

24. A method of simulating a card game for playing by a player, the game being in the form in which a hand of cards is dealt to the player, the method including:
receiving instructions initiated by a player and relating to the playing of the game;
providing data for creating a display image representing the current state of the game being played; and
maintaining a record of the current state of the game being played, modifying the record in accordance with the rules of the game, and causing the display image data to be updated as the game progresses;
and wherein the display image data is caused to create an image of a player hand which includes at least one obscured card when first dealt, and is modified in accordance with player instructions received, to cause the created image to reveal the or each obscured card in a manner determined by the player.

25. A method according to claim 24, in which the obscured card or cards are revealed at a speed and/or order and/or time set by the player.

26. A method according to claims 24 or 25, in which the method causes an image of a partially revealed card to be provided to a player.

27. A method according to any of claims 24 to 26, in which initially, all cards of the player hand are obscured.

28. A method according to any of claims 24 to 27, in which the display image data causes an obscured card to be represented by an image of a face down card.

29. A method according to any of claims 24 to 28, in which the instructions and/or display image data are transmitted over a network.

30. Gaming apparatus operable by a player to simulate a card game in which a hand of cards is dealt to the player, the apparatus comprising:
input means operable to receive instructions initiated by a player and relating to the playing of the game;
output means operable to provide data for creating a display image representing the current state of the game being played, and
control means operable to maintain a record of the current state of the game being played, to modify the record in accordance with the rules of the game, and to cause the display image data to be updated as the game progresses;
and wherein the apparatus is operable to receive a player instruction representing at least one wager criterion, and to assess the player hand in accordance with the wager criterion or criteria, and to effect the placing of a wager, without player intervention, in the event that the wager criterion or criteria are met.

31. Apparatus according to claim 30, in which a wager criterion is interpreted as a minimum hand strength required for a wager to be placed.

32. Apparatus according to claim 31, in which the cards of a player hand are sequentially assessed by the control means and a wager is placed if the hand meets the or a wager criterion, without further assessment being made.

33. Apparatus according to any of claims 30 to 32, in which the apparatus is operable to cause the display image data to create an image of a player hand which includes at least one obscured card when first dealt.

34. Apparatus according to claim 33 when dependent on claim 32, in which cards remain obscured if they have not been incorporated in an assessment of the strength of the hand against the wager criterion or criteria.

35. Apparatus according to claims 33 or 34, in which the apparatus is further operable to modify the display image data in accordance with player instructions received by the input means, to cause the created image to reveal the or each obscured card in a manner determined by the player.

36. Computer software which, when installed on a computer system, is operable to provide gaming apparatus according to any of claims 30 to 35.

37. A carrier medium carrying computer software according to claim 36.

38. A carrier medium according to claim 37, in which the carrier medium is a memory device.

39. Gaming apparatus operable by a player for the simulation of a card game in which a hand of cards is dealt to the player; the apparatus comprising:
player control means operable by a player to initiate instructions relating to the playing of the game; and
display means operable to receive image data representing the current state of a game being played and to create a display image corresponding thereto;
the player instructions being sent to, and the display image data being received from control means operable to maintain a record of the current state of the game being played, to modify the record in accordance with the rules of the game, and to cause the display image data to be updated as the game progresses, and wherein the control means is further operable to receive a player instructions representing at least one wager criterion, and to assess the player hand in accordance with the criterion or criteria, and to effect the placing of a wager, without player intervention, in the event that the wager criterion or criteria are met.

40. Apparatus according to claim 39, in which a wager criterion is interpreted as a minimum hand strength required for a wager to be placed.

41. Apparatus according to claim 40, in which the cards of a player hand are sequentially assessed by the control means and a wager is placed if the hand meets the or a wager criterion, without further assessment being made.

42. Apparatus according to any of claims 39 to 41, in which the apparatus is operable to cause the display image data to create an image of a player hand which includes at least one obscured card when first dealt.

43. Apparatus according to claim 42 when dependent on claim 41, in which cards remain obscured if they have not been incorporated in an assessment of the strength of the hand against the wager criterion or criteria.

44. Apparatus according to claims 42 or 43, in which the apparatus is further operable to modify the display image data in accordance with player instructions received by the input means, to cause the created image to reveal the or each obscured card in a manner determined by the player.

45. Computer software which, when installed on a computer system, is operable to provide gaming apparatus according to any of claims 39 to 44.

46. A carrier medium carrying computer software according to claim 45.

47. A carrier medium according to claim 46, in which the carrier medium is a memory device.

48. A signal propagating on a transmission medium, the signal representing software which, when installed on a computer system, is operable to provide gaming apparatus according to any of claims 39 to 44.

49. A method of simulating a card game for playing by a player, the game being in the form in which a hand of cards is dealt to the player, the method including:
receiving instructions initiated by a player and relating to the playing of the game;
providing data for creating a display image representing the current state of the game being played; and
maintaining a record of the current state of the game being played, modifying the record in accordance with the rules of the game, and causing the display image data to be updated as the game progresses;
and wherein a player instruction representing at least one wager criterion is received, and the player hand is assessed in accordance with the criterion or criteria, and a wager is placed, without player intervention, in the event that the wager criterion or criteria are met.

50. A method according to claim 49, in which a wager criterion is interpreted as a minimum hand strength required for a wager to be placed.

51. A method according to claim 50, in which the cards of a player hand are sequentially assessed and a wager is placed if the hand meets the or a wager criterion, without further assessment being made.

52. A method according to any of claims 49 to 51, in which an image of a player hand is created which includes at least one obscured card when first dealt.

53. A method according to claim 52 when dependent on claim 51, in which cards remain obscured if they have not been incorporated in an assessment of the strength of the hand against the wager criterion or criteria.

54. A method according to claims 52 or 53, in which the display image data is modified in accordance with player instructions received by the input means, to cause the created image to reveal the or each obscured card in a manner determined by the player.

55. Gaming apparatus substantially as hereinbefore described and with reference to the accompanying drawings.

56. Computer software substantially as hereinbefore described and with reference to the accompanying drawings.

57. A carrier member substantially as hereinbefore described and with reference to the accompanying drawings.

58. A signal propagating on a transmission medium substantially as hereinbefore described and with reference to the accompanying drawings.

59. A method of simulating a card game for playing by a player substantially as hereinbefore described and with reference to the accompanying drawings.

60. Any novel subject matter or combination including novel subject matter disclosed herein, whether or not within the scope of or relating to the same invention as any of the preceding claims.
